(19) United States
(12) Patent Application Publication
(10) Pub. No.: US 2024/0190515 A1
(43) Pub. Date: Jun. 13, 2024

(54) Vehicle Cockpit for a Motor Vehicle

(71) Applicant: Bayerische Motoren Werke Aktiengesellschaft, Muenchen (DE)

(72) Inventor: Bernhard SCHMID, Hallbergmoos (DE)

(21) Appl. No.: 18/286,260

(22) PCT Filed: Apr. 19, 2022
(86) PCT No.: PCT/EP2022/060263

§ 371 Date: Oct. 10, 2023

(30) Foreign Application Priority Data
May 18, 2021 (DE) 10 2021 112 858.7

(51) Int. Cl. B62D 25/14; B60K 35/50; B60K 37/10

(52) U.S. Cl. CPC B62D 25/14; B60K 35/50; B60K 37/10; B60K 2360/828; B60K 2360/84

(57) ABSTRACT

A vehicle cockpit of modular design for a motor vehicle, with a dashboard lower part and with a dashboard upper part and with a technology carrier which is arranged between the dashboard lower part and the dashboard upper part. The vehicle cockpit extends along a vehicle transverse axis from a left-hand A-pillar to a right-hand A-pillar. The vehicle cockpit can be fastened to a supporting tube. The technology carrier extends over between 60% and 90% of a width of the vehicle cockpit along the vehicle transverse axis and is replaceable. On account of the design of the vehicle cockpit, a simple replacement of operating and/or display elements for an update to the latest state of the art is possible.

### BACKGROUND AND SUMMARY

The invention relates to a vehicle cockpit for a motor vehicle and also to a motor vehicle with such a vehicle cockpit.

With regard to the technical environment, attention is drawn to German published application DE 10 2006 025 386 A1, for instance, from which a vehicle cockpit with a head-up display (HUD) is known. This published application discloses a vehicle cockpit with a head-up display, with a transverse member and with a bulkhead for separating the cockpit from the engine compartment. In order to be able to assemble the head-up display easily, fastening means are provided for a preassembly of the head-up display on the transverse member and for a final assembly on a further supporting component of the vehicle body. As a result, the transverse member with the preassembled head-up display is capable of being inserted into the vehicle as a module.

Furthermore, another vehicle cockpit of modular construction is known from the international patent application having international publication number WO 01/12458 A1.

A paneling element for interior finishing, in particular of motor vehicles, is known from German utility-model specification DE 298 21 991 U1. The paneling element consists of several parts—for example, a covering, a foam part and a supporting body—all the parts consisting of the same material family, preferentially of the same material.

Furthermore, a vehicle cockpit with self-supporting submodules is known from German published application DE 10 2006 025 384 A1, which the present invention takes as its starting-point. A vehicle cockpit of modular design is disclosed, with at least one transverse member extending across the width of the cockpit and with at least two or three submodules which accommodate components and which are each capable of being fastened to the transverse member. In order to make a vehicle cockpit of modular design available that simplifies the manufacturing procedure, the submodules are self-supporting, in order to be capable of being handled freely as preassembled subassemblies and in order to transmit their own weight and external loads to the transverse members in the installed state. This published application is also concerned with a method for assembly and a method for installation of a vehicle cockpit of modular design.

By reason of the rapid technical further development in the field of electronics, an upgrading of the electronic components of the vehicle cockpit to the latest state of the art is frequently already necessary for a reworking of a motor-vehicle model, in order to remain of interest also to second or third customers. Modern vehicle cockpits are produced nowadays from many individual components such as carriers, decorative elements, etc. The contents thereof can be altered only within the same construction space. In the case of differently shaped, novel components, an extensive alteration of the cost-intensive components is necessary.

This further development is very time-consuming and costly in a negative manner.

It is an object of the present invention to provide a measure by which a vehicle cockpit for a motor vehicle can be adapted to, or exchanged for, the latest state of the art—in particular, the latest state of electronics—in a straightforward manner.

This object is achieved for a generic vehicle cockpit in that the first technology-carrier extends over a distance amounting to between 60% and 90% of a width of the vehicle cockpit along the transverse axis of the vehicle, and is interchangeable.

In accordance with the invention, the separation of an updatable subregion from the previous manifestation of a carrier and the merging with attachments to form new component units—the first technology-carrier—are proposed. By reason of this innovation, it is possible to exchange the technology-carrier separately in a straightforward manner and to keep it up to date in accordance with the current state of the art.

In a development of the invention, a second technology-carrier is arranged between the lower part of an instrument panel and the upper part of the instrument panel, below or above the first technology-carrier, the second technology-carrier extending over a distance amounting to between 60% and 90% of the width of the vehicle cockpit along the transverse axis of the vehicle, at least one technology-carrier being interchangeable. By virtue of this development according to the invention, at least one technology-carrier is capable of being exchanged in a straightforward manner independently of the other technology-carrier. Of course, both technology-carriers may also be exchanged simultaneously, in order—if need be—to keep both technology-carriers in accord with the current state of the art.

According to another aspect, at least one technology-carrier is preferably capable of being fastened in the vehicle cockpit with a multi-hook quick-acting closure system. In an advantageous development, both technology-carriers are capable of being fastened in the vehicle cockpit with a multi-hook quick-acting closure system. By reason of this configuration according to the invention, at least one technology-carrier is capable of being exchanged quickly, and independently of the second technology-carrier, without unnecessary expenditure on tooling or assembly being necessary for this purpose. Multi-hook quick-acting closure systems are known to a person skilled in the art and will therefore not be elucidated further.

In another particularly preferred embodiment, at least one technology-carrier has been manufactured or produced largely from a single material. Both technology-carriers have preferably been produced from the single material. Consequently, a simple, homogeneous and cost-effective recycling of the technology-carriers is possible.

According to another aspect, this single material is preferably a synthetic material such as polypropylene (PP), for instance. In other embodiments, lightweight metals such as aluminum alloys or magnesium alloys, for example, may also be employed.

As the name already expresses, at least one technology-carrier has been provided for accommodating at least one electrical or electronic control element and/or display element. In this connection it may be a question of, for instance, electric push-buttons or knobs or, for instance, a display screen for a navigation device.

In preferred manner, at least one technology-carrier is interchangeable jointly with the electrical or electronic control element and/or display element.

In another particularly preferred embodiment, the lower part of the instrument panel has been provided for structurally differing motor vehicles. Consequently, one and the same lower part of the instrument panel can be employed for differing types of vehicle. The lower part of the instrument panel is ordinarily not visible to the driver or front passenger, but the identical-parts principle reduces the manufacturing costs advantageously. Merely fastening-points for the lower part of the instrument panel may possibly have to be adapted.

In a further development, the upper part of the instrument panel has been provided for structurally identical motor vehicles. This upper part of the instrument panel is very readily visible to the driver or front passenger, so the identical-parts principle can be employed for structurally identical motor vehicles (with the same design surface) and consequently likewise reduces the production costs advantageously.

The configuration according to another aspect, namely that at least one cavity for a stiffening of the technology-carrier and/or an air duct has been integrated within the at least one technology-carrier, results in a structural standardization of the technology-carrier and, in addition, cuts down on further components, for the air duct for instance.

In an advantageous embodiment, at least one air-vent housing has been integrated within the at least one technology-carrier. Also by virtue of this integration, separate components for a vehicle cockpit according to the invention once again become unnecessary.

Furthermore, a motor vehicle with a vehicle cockpit according to the invention is disclosed.

The invention is elucidated in more detail in the following with reference to nine figures.

### BRIEF DESCRIPTION OF THE DRAWINGS

FIG. 1 is a view of a vehicle cockpit according to an embodiment of the invention.

FIG. 2 is a view of a vehicle cockpit for a first vehicle.

FIG. 3 is a view of a vehicle cockpit for a second vehicle.

FIG. 4 is a rear view of FIG. 2.

FIG. 5 is a rear view of FIG. 3.

FIG. 6 is a first rear view of a lower part of the instrument panel.

FIG. 7 is a second rear view of the lower part of the instrument panel.

FIG. 8 is a rear view of the first technology-carrier for the first motor vehicle.

FIG. 9 is a rear view of the first technology-carrier for the second motor vehicle.

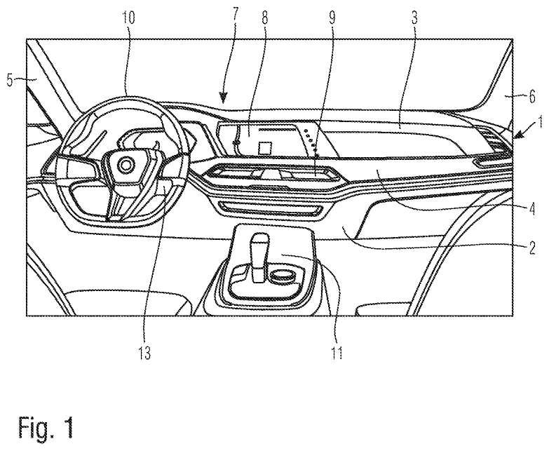

In the following, the same reference numerals apply to FIGS. 1 to 9 for identical components.

### DETAILED DESCRIPTION OF THE DRAWINGS

FIG. 1 shows a view of a vehicle cockpit 1 for a motor vehicle (not represented in detail). The view of the vehicle cockpit 1 is shown from between unnumbered backrests of a driver's seat and of a front passenger's seat in the direction of travel of the motor vehicle. In the middle, in the direction of view in front of the vehicle cockpit 1, a center console 11 with operating elements (which are not numbered) is arranged. The vehicle cockpit 1 extends behind the center console 11 across an entire interior width of the motor vehicle.

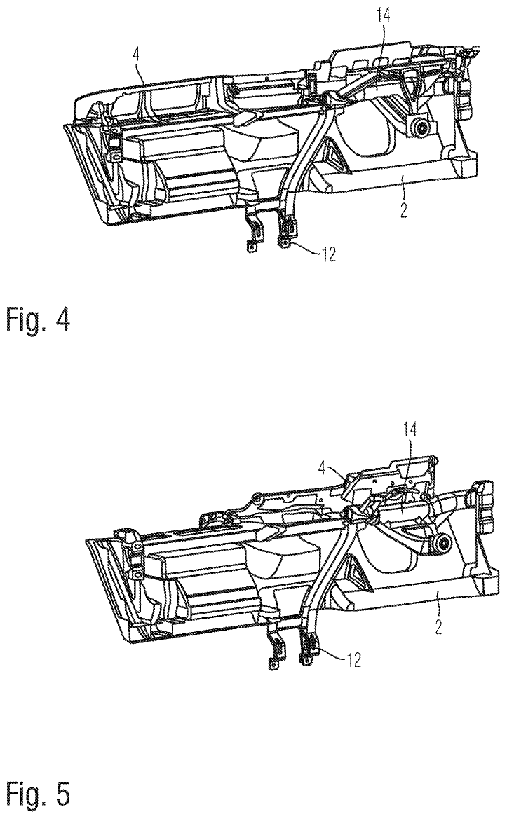

The vehicle cockpit 1 consists of a lower part 2 of the instrument panel and also of an upper part 3 of the instrument panel, arranged above the lower part. In the lower part 2 of the instrument panel a light-catching edge of an unnumbered glove compartment is discernible in front of the seat of the front passenger. The vehicle cockpit 1 has been constructed in a modular design. A first technology-carrier 4 is arranged between the lower part 2 of the instrument panel and the upper part 3 of the instrument panel. As already mentioned, the vehicle cockpit 1 extends along a transverse axis of the vehicle from a left A-pillar 5 as far as a right A-pillar 6 and is capable of being fastened to a supporting tube 14, represented in portions, which is discernible in FIGS. 4, 5 and 8, 9. This supporting tube 14 is also called a supporting structure and ordinarily extends from the left A-pillar 5 as far as the right A-pillar 6 and serves for fastening the vehicle cockpit 1 or several individual parts thereof.

In accordance with the invention, the first technology-carrier 4 in the present exemplary embodiment extends over a distance amounting to 90% of a width of the vehicle cockpit 1 along the transverse axis of the vehicle, and is interchangeable. The first technology-carrier 4 preferably extends over a distance amounting to between 60% and 90% of the width of the vehicle cockpit 1 along the transverse axis of the vehicle.

Furthermore, a second technology-carrier 7 is arranged between the lower part 2 of the instrument panel and the upper part 3 of the instrument panel, above the first technology-carrier 4. This second technology-carrier likewise preferably extends over a distance amounting to between 60% and 90% of the width of the vehicle cockpit 1 along the transverse axis of the vehicle, at least one of the two technology-carriers 4, 7 being interchangeable. The second technology-carrier 7 is not discernible in FIG. 1, since it is arranged behind the upper part 3 of the instrument panel. However, its location has been marked by an arrow.

A display element 8 which also acts at the same time as a control element, since it is touch-sensitive, is arranged centrally in technology-carrier 4. To the left alongside the display element 8, the conventional motor-vehicle indicators—such as, for instance, a tachometer for an internal-combustion engine and/or a speed-indicator for a current driving speed—are arranged behind a steering wheel 10 with a steering column 13. Furthermore, two air-vent housings 9, only one of which is numbered, are arranged in technology-carrier 4. In the present exemplary embodiment, both technology-carriers 4, 7 are capable of being fastened in the vehicle cockpit 1 with a multi-hook quick-acting closure system, and are interchangeable. In another exemplary embodiment, only one technology-carrier 4, 7 may have been provided with a multi-hook quick-acting closure system, whereas the second has been built in conventionally.

The technology-carriers 4, 7 are preferably produced largely from a single material which is preferentially a synthetic material such as polypropylene (PP), for instance. Other synthetic materials are also possible. By virtue of this configuration, the technology-carriers 4, 7 can be recycled homogeneously. Instead of a synthetic material, a lightweight metal such as a magnesium alloy or an aluminum alloy, for example, may also be employed.

As can be discerned in FIG. 1, the first technology-carrier 4 exhibits at least one control element and/or display element 8. In addition, the second technology-carrier 7 may also be provided for accommodating at least one control element and/or display element 8. Preferably, at least one technology-carrier 4, 7 is interchangeable jointly with the control element and/or display element 8. In this way, the electronic components can always be kept up to date—that is to say, in accord with the latest state of the art.

Particularly preferably, as in the present exemplary embodiment, at least one cavity for a stiffening of the technology-carrier 4, 7 and/or for an air duct has been integrated within a technology-carrier 4, 7. In addition, at least one air-vent housing 9 may have been integrated within at least one technology-carrier 4, 7—in the present exemplary embodiment, within the first technology-carrier 4.

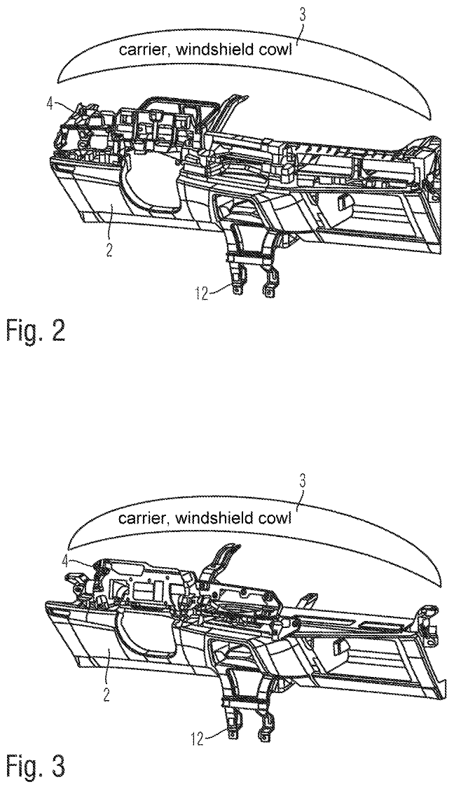

FIG. 2 shows a view of the vehicle cockpit 1, consisting of the lower part 2 of the instrument panel and also of the first technology-carrier 4 and the upper part 3 of the instrument panel (cowl carrier) for a first motor vehicle. The lower part 2 of the instrument panel exhibits several fastening straps 12 for fastening the lower part 2 of the instrument panel to the supporting tube 14. Only a single fastening strap 12 is numbered.

FIG. 3 shows a view of the vehicle cockpit 1, consisting of the lower part 2 of the instrument panel and also of the first technology-carrier 4 and the upper part 3 of the instrument panel (cowl carrier) for a second motor vehicle. As can be discerned in FIGS. 2 and 3, the first technology-carriers 4 in FIGS. 2 and 3 are of differing geometrical construction, in order to accommodate differing control instruments and/or display instruments 8 for differing motor vehicles.

FIG. 4 shows a rear view of the lower part 2 of the instrument panel and of the first technology-carrier 4 for the first motor vehicle from FIG. 2. Also discernible is a portion of the supporting tube 14 which extends from the left A-pillar 5 as far as the right A-pillar 6.

FIG. 5 shows a rear view of the lower part 2 of the instrument panel and of the first technology-carrier 4 for a second motor vehicle from FIG. 3. Also in FIGS. 4 and 5, it is discernible that the first technology-carrier 4 for the first motor vehicle is structurally different geometrically from the first technology-carrier 4 for the second motor vehicle.

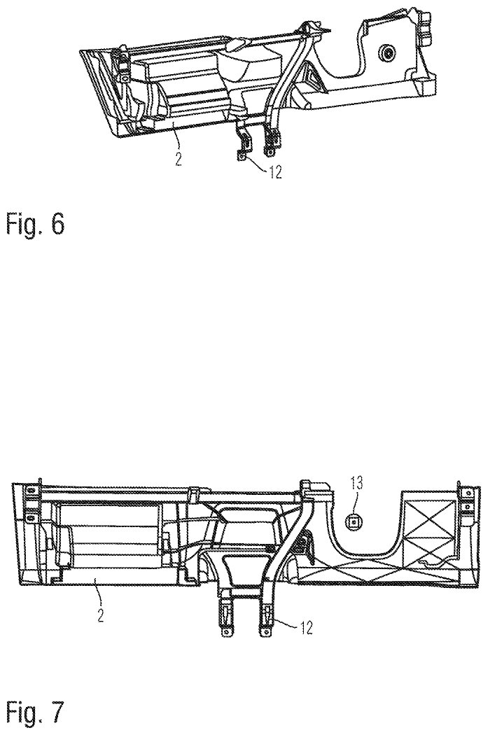

FIG. 6 shows once again a rear view of the lower part 2 of the instrument panel with its fastening straps 12, in an isometric representation. The lower part 2 of the instrument panel with the fastening straps 12 is capable of being fastened to the supporting tube 14, for instance with screws which are not represented.

FIG. 7 shows a view of the lower part 2 of the instrument panel from FIG. 6. In FIG. 7 the steering-column assembly 13 has also been drawn in. Since the lower part 2 of the instrument panel is ordinarily not directly visible to the driver and front passenger, this lower part has preferentially been provided for structurally differing motor vehicles. This identical-parts principle economizes on production costs.

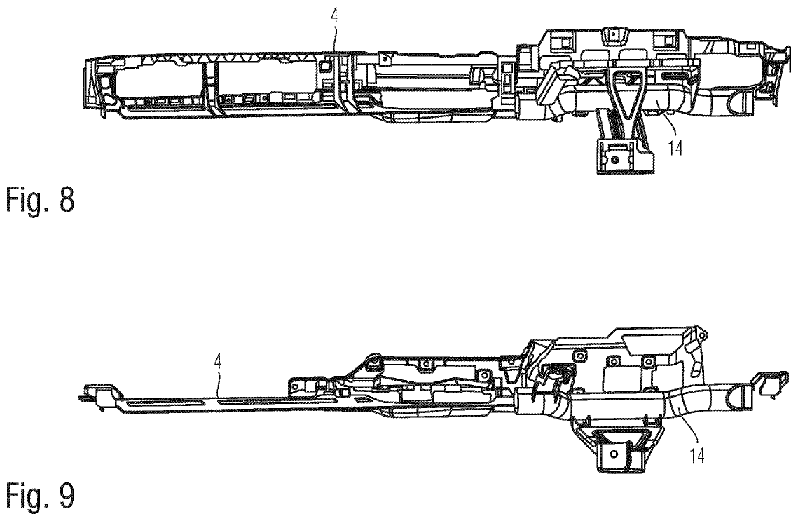

FIG. 8 shows a rear view of the first technology-carrier 4 for the first motor vehicle, with the portion of the supporting tube 14.

FIG. 9 shows a rear view of the first technology-carrier 4 for the second motor vehicle, with the portion of the supporting tube 14. Also in FIGS. 8 and 9, it is discernible that each technology-carrier 4, 7 has been constructed differently for a different motor vehicle.

Summarizing, the following may be stated.

Regions of the vehicle cockpit 1 with electronics (middle of the instrument panel and region of the head-up display (HUD) with regions of a windshield root) are, according to the invention, separate carriers, so-called technology-carriers 4, 7. These technology-carriers 4, 7 are recombined for cost efficiency. The region in the middle of the instrument panel replaces all the technology-carriers 4, 7 in this region and is merged with the decor. Optionally, a hollow geometry which can be utilized for stiffening and/or for air guidance may also be generated thereby. Subregions of the air-vent housings 9 can also be reproduced with it. The head-up-display region with windshield root is, for example, merged with the head-up-display screen and the defroster screen.

In accordance with the invention, the following advantages arise:
cost-reduction with one-time expenditure;
reduction of production costs, part-numbers and service costs;
update capability of the technology-carriers 4, 7;
minimization of update costs through cross-derivative approach;
recyclability with respect to material utilization.

### LIST OF REFERENCE SIGNS

1. vehicle cockpit
2. lower part of the instrument panel
3. upper part of the instrument panel
4. first technology-carrier
5. left A-pillar
6. right A-pillar
7. second technology-carrier
8. control element and/or display element
9. air-vent housing
10. steering wheel
11. center console
12. fastening strap
13. steering-column assembly
14. supporting tube

1.-12. (canceled)

13. A vehicle cockpit of modular design for a motor vehicle, comprising:
a lower part of an instrument panel;
an upper part of the instrument panel;
a first technology-carrier arranged between the lower part of the instrument panel and the upper part of the instrument panel, wherein
the vehicle cockpit extends along a transverse axis of the vehicle from a left A-pillar as far as to a right A-pillar, and is fastenable to a supporting tube, and
the first technology-carrier extends over a distance amounting to between 60% and 90% of a width of the vehicle cockpit along the transverse axis of the vehicle, and the first technology-carrier is interchangeable.

14. The vehicle cockpit according to claim 13, further comprising:
a second technology-carrier arranged between the lower part of the instrument panel and the upper part of the instrument panel, below or above the first technology-carrier, wherein
the second technology-carrier extends over a distance amounting to between 60% and 90% of the width of the vehicle cockpit along the transverse axis of the vehicle, and
at least one of the first or second technology-carriers is interchangeable.

15. The vehicle cockpit according to claim 14, wherein
at least one of the first or second technology-carriers is fastenable in the vehicle cockpit with a multi-hook quick-acting closure system.

16. The vehicle cockpit according to claim 13, wherein
at least one of the first or second technology-carriers is formed of a single material.

17. The vehicle cockpit according to claim 16, wherein the material is a synthetic material.

18. The vehicle cockpit according to claim 13, wherein
at least one of the first or second technology-carriers is configured to accommodate a control element and/or a display element.

19. The vehicle cockpit according to claim 18, wherein
at least one of the first or second technology-carriers is interchangeable jointly with the control element and/or the display element.

20. The vehicle cockpit according to claim 13, wherein
the lower part of the instrument panel is provided for structurally differing motor vehicles.

21. The vehicle cockpit according to claim 20, wherein
the upper part of the instrument panel is provided for motor vehicles of identical construction.

22. The vehicle cockpit according to claim 13, wherein
at least one cavity configured to stiffen the technology-carrier and/or an air duct is integrated into the technology-carrier.

23. The vehicle cockpit according to claim 13, wherein
at least one air-vent housing is integrated into at least one of the first or second technology-carriers.

24. A motor vehicle comprising a vehicle cockpit according to claim 13.
